(19) United States
(12) Patent Application Publication
(10) Pub. No.: US 2011/0209710 A1
(43) Pub. Date: Sep. 1, 2011

(54) FILTERED BANDANAS

(76) Inventor: Carlos J. SPENCER, III, (US)

(21) Appl. No.: 13/036,509

(22) Filed: Feb. 28, 2011

Related U.S. Application Data
(60) Provisional application No. 61/308,608, filed on Feb. 26, 2010.

(51) Int. Cl. A62B 7/10

(52) U.S. Cl. 128/206.12

(57) ABSTRACT

A breathing mask includes a sheet of flexible material folded on itself, resulting in a first layer and a second layer, a filter located between the first layer and the second layer, and a nose bridge located along an edge of the folded sheet, the nose bridge configured to form a seal between the folded sheet and a user's nose when the mask is placed on a user's face.

### CROSS-REFERENCE TO RELATED APPLICATIONS

This application claims priority under 35 U.S.C. §119(e) to provisional U.S. patent application Ser. No. 61/308,608, filed on Feb. 26, 2010, the disclosure of which is expressly incorporated by reference herein in its entirety.

### BACKGROUND OF THE PRESENT DISCLOSURE

1. Field of the Present Disclosure

The present disclosure is directed to a stylish garment or bandana that incorporates an air filter to provide a user a higher level of respiratory protection.

2. Related Art

Many devices are available to provide a casual or low-risk user with protection from particulate matter and other airborne contaminants. Examples include cotton bandanas and paper masks commonly available at hardware stores. Casual or low-risk users may include landscapers, gardeners, allergy sufferers, dirt bike riders, and the like. Firefighter, asbestos workers, and the like may be considered professional or high-risk users.

Cotton bandanas may provide a good fit and good airflow, but their loose, open weave may not provide adequate, or even noticeable, filtration. Paper masks may provide adequate filtration, but they may suffer from poor fit, poor airflow, or both.

Allergy sufferers may also turn to medications, rather than a breathing mask, to relieve their symptoms. Many allergy medications, however, need a considerable period of time before they begin to work. This means that a person who suffers from allergies must either take the medication in anticipation of exposure to allergens or suffer from the symptoms while waiting for the medication to work. There is no possibility for immediate relief. In addition, allergy medications may cause undesirable side effects, including drowsiness, dizziness, and headaches.

Accordingly, there is a need for a stylish wearable personal air filter that is comfortable and provides both adequate filtration and air flow to provide a user a higher level of respiratory protection.

### SUMMARY OF THE PRESENT DISCLOSURE

The present disclosure meets the foregoing need and allows filtration using a large filter, which results in a significant air flow and filtration and other advantages apparent from the discussion herein.

Accordingly, in one aspect of the present disclosure a breathing mask includes a sheet of flexible material folded on itself, resulting in a first layer and a second layer, a filter located between the first layer and the second layer, and a nose bridge located along an edge of the folded sheet, the nose bridge configured to form a seal between the folded sheet and a user's nose when the mask is placed on a user's face.

According to another aspect of the present disclosure a breathing mask includes a sheet of fabric folded on itself, resulting in a first layer and a second layer, a filter sandwiched between the first layer and the second layer, and a nose bridge located along an edge of the folded sheet, the nose bridge configured to form a seal between the folded sheet and a user's nose when the breathing mask is placed on a user's face.

In yet another aspect of the present disclosure a breathing mask includes a sheet of fabric folded on itself, resulting in a first layer and a second layer, a filter located between the first layer and the second layer, and a nose bridge located along an edge of the folded sheet, the nose bridge configured to form a seal between the folded sheet and a user's nose when the mask is placed on a user's face.

Additional features, advantages, and embodiments of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the present disclosure, are incorporated in and constitute a part of this specification, illustrate embodiments of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 shows an exemplary arrangement of the components of a filtered bandana, according to the principles of the present disclosure;

FIGS. 2a and 2b show alternate arrangements of the components of a filtered bandana; and

FIG. 3 shows a completed filtered bandana, including optional surface components.

### DETAILED DESCRIPTION OF THE PRESENT DISCLOSURE

The embodiments of the present disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present disclosure. The examples used herein are intended merely to facilitate an understanding of ways in which the present disclosure may be practiced and to further enable those of skill in the art to practice the embodiments of the present disclosure. Accordingly, the examples and embodiments herein should not be construed as limiting the scope of the present disclosure, which is defined solely by the appended claims and applicable law. Moreover, it is noted that like reference numerals represent similar parts throughout the several views of the drawings.

According to an aspect of the present disclosure, a piece of a flexible material may be fitted with a filter. Suitable types of flexible material may include fabric, plant textiles, animal textiles, mineral textiles, synthetic textiles, cloth, cotton, nylon, silk, satin, vinyl, paper, yarn, flax, wool, hemp, modal, bamboo, metal foil, metal screen, metal wire, polyester, aramid, acrylic, spandex, olefin, ingeo, milk fiber textile, nanomaterials, and the like. The flexible material may optionally be treated or manufactured with nanoparticles to, e.g., increase resistance to water or to add antibacterial properties.

The filter may, e.g., be a blend of cotton and bamboo fibers. A cotton/bamboo filter may be environmentally friendly due to the renewability of both cotton and bamboo, as well as the increased carbon dioxide absorption of bamboo. A cotton/bamboo filter may have excellent filtration and breathability properties, and it may be soft, supple, and easily washable. In addition, the bamboo fibers may have naturally occurring anti-bacterial properties. The filter may also be formed of any type of material that may provide an increased level of respiratory protection from dirt, dust, allergens, and the like.

Other appropriate filter media include, e.g., cotton, nylon, paper, bamboo, hemp, recycled plastic, foam, and the like. The filter may optionally be treated or manufactured with nanoparticles to, e.g., increase the filter's antibacterial properties. The flexible material and filter combination (hereinafter referred to as a “garment” or “bandana,” although other configurations, constructions, and arrangements are contemplated and within the spirit and scope of the disclosure and attached claims) may be worn on a person's face for the purpose of, e.g., filtering the air breathed by the wearer. In this regard, any filter that suitably removes particulate matter, such as, e.g., dust, pollen, smoke, allergens, and the like, without noticeably or appreciably restricting the flow of air to the wearer is contemplated and within the spirit and scope of the present disclosure and attached claims.

A nose bridge may be attached to the garment by means of sewing, stitching, seam tape, epoxy, adhesive, or the like. The nose bridge may be made, for example, of a strip of a rigid but bendable material. Other shapes, configurations, and materials are contemplated and within the spirit and scope of the present disclosure and attached claims. The nose bridge may be used, for example, to ensure a tight or formed fit across the wearer's nose and cheekbones, thereby improving the quality of the fit and eliminating or reducing gaps or spaces between the garment and the wearer's face.

A set of earplugs may be attached to the garment with a cord. The cord may be laced through the flexible material near the nose bridge, or the cord may extend through holes (or openings) in the fabric. Additional types of construction and attachment are contemplated and with the scope and spirit of the present disclosure and attached claims. The earplugs may protect the wearer's ears from noise and/or particulate matter. In one aspect, the garment may utilize earplugs with, e.g., a 32 dB rating.

The garment, as shown and described, may be used by any person, including, e.g., a person concerned for personal safety. In particular, the garment may be used by any person who suffers from allergies, asthma, chronic bronchitis, emphysema, chronic obstructive pulmonary disease (COPD), or the like. The garment may further be used by persons who are exposed to or are sensitive to airborne particulate matter, including dust, pollen, dander, asbestos, smoke, dirt, waste, refuse, and the like. Such persons may include, e.g., allergy sufferers; construction workers; landscapers; gardeners; firefighters; people exposed to smoke from forest fires, wild fires, and the like; farmers; ranchers; dirt bike riders; motorcycle riders; and the like.

The garment, however, is not limited to use by persons. Instead, the garment may be used by animals. For example, the garment may be worn by an animal such as, for example, a dog, a cat, a horse, or the like.

The garment may be washable and reusable, thereby increasing its lifespan, value, and/or environmental friendliness. The garment may also be branded with a logo to promote a company, sports team, charity, school, or the like. Branding may be achieved by screen printing, embroidery, or any other suitable technique known to one skilled in the art.

The garment may also incorporate a closure device instead of requiring the wearer to tie loose ends of the bandana together. Suitable closure devices include, for example, straps, snaps, buckles, elastic, hooks, and the like. Additional straps may be incorporate to allow the wearer to improve or adjust the fit of the garment to the wearer's face. These additional straps may be made from any appropriate material, including canvas, cloth, elastic, and the like. The garment may be designed so that it completely encircles more or all of the head, rather than simply covering the wearer's nose and mouth.

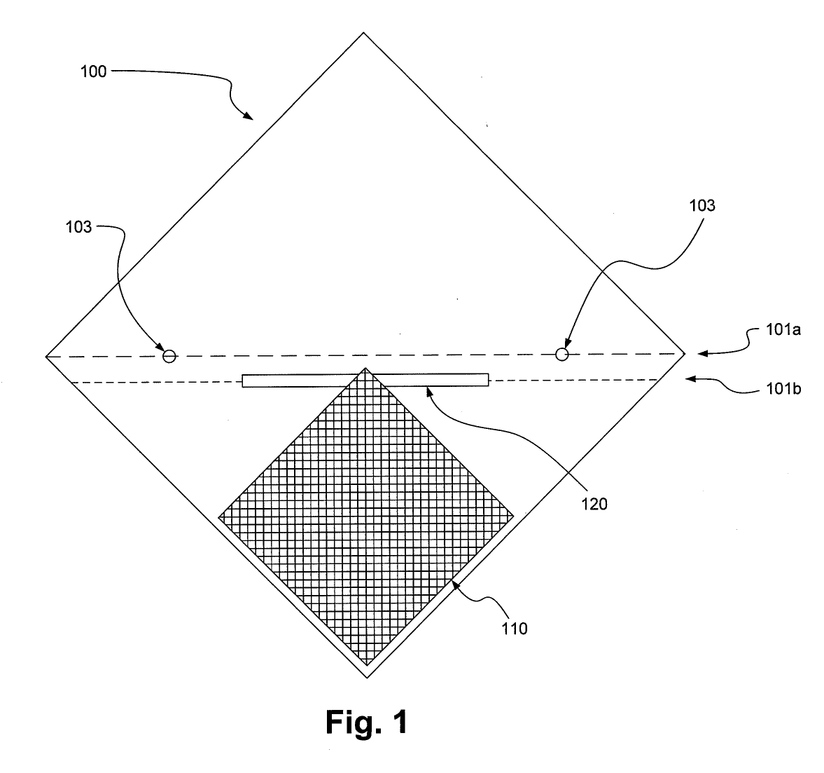

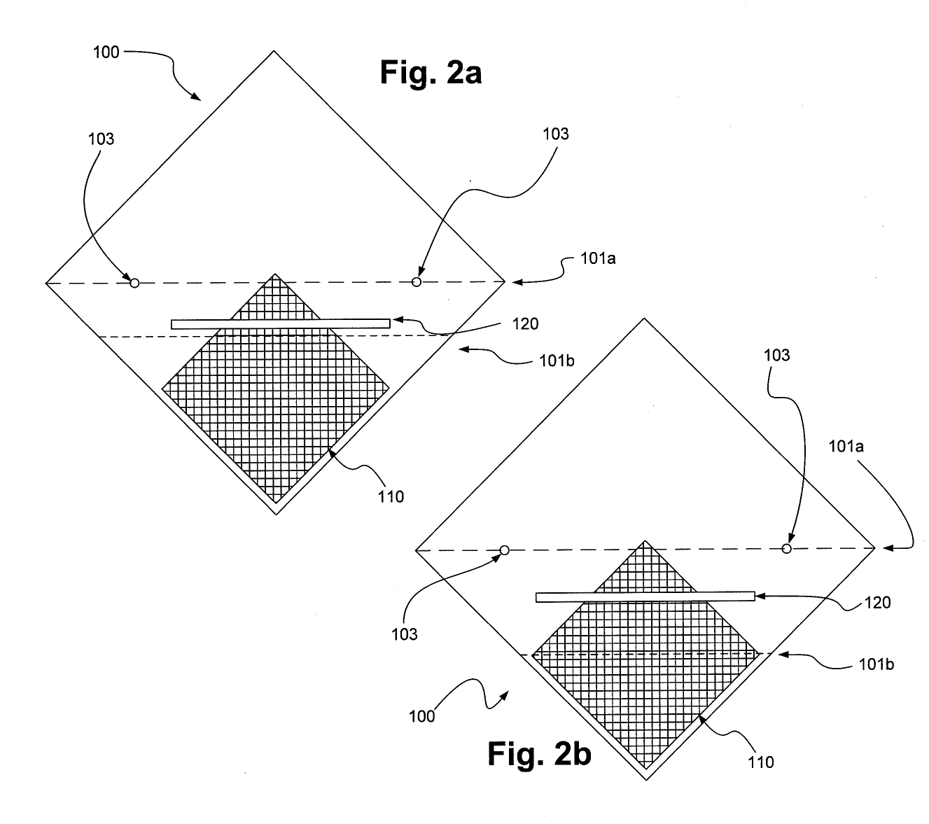

FIGS. 1, 2a, and 2b show possible and exemplary arrangements of the components of the garment (or a filtered bandana). Additional arrangements are possible without departing from the scope and spirit of the disclosure, as will be understood by one having ordinary skill in the art.

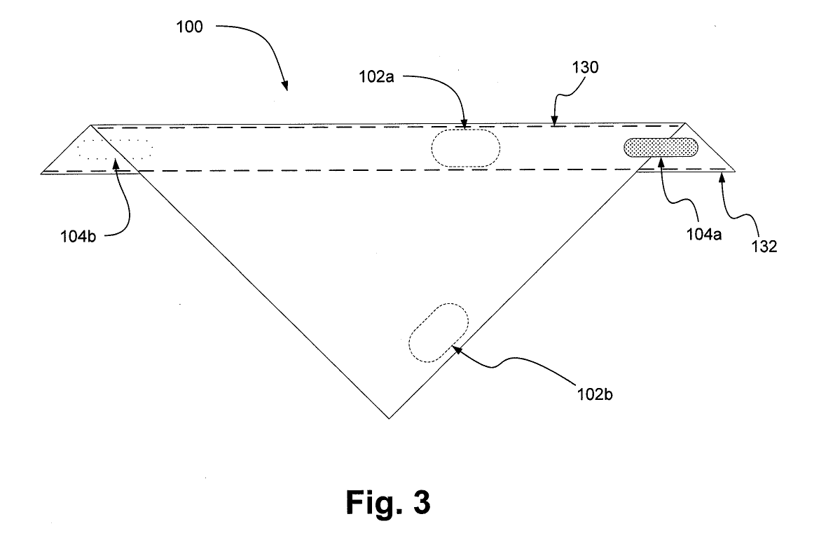

A filtered bandana (or breathing mask) according to the principles of the present disclosure may be made using the following steps. These steps are for non-limiting example purposes only. They may be modified, altered, reordered, replaced, or disregarded without departing from the spirit and scope of the present disclosure, including the attached claims.
1. A piece of fabric 100, which may have a square shape, may be placed in a diamond orientation.
2. A filter material 110, which may also have a square shape, may be placed near one of the corners of the piece of fabric 100, as shown, e.g., in FIG. 1. The filter 110 may be held in place by any means known to those skilled in the art, including, e.g., seam tape, stitching, sewing, glue, epoxy, and the like. Alternatively, the filter material 110 may be integrally formed with the piece of fabric 100.
3. A nose bridge 120 may be placed on the piece of fabric 100, as shown, e.g., in FIG. 1. The nose bridge may be held in place by any means known to those skilled in the art, including, e.g., seam tape, stitching, sewing, glue, epoxy, and the like.
4. Optionally, holes (or openings) for earplugs 103 may be cut or formed in the piece of fabric 100. Corded earplugs (not shown) may be threaded through these holes and attached to the piece of fabric 100 by any appropriate means, including, e.g., seam tape, stitching, sewing, glue, epoxy, and the like.
5. The piece of fabric 100 may be folded in half, e.g., along fold 101a to form a first layer and a second layer of the fabric 100. The fold 101a may be ironed to make it crisp. All or a portion of the bandana perimeter may be stitched, sewed, glued, or otherwise attached at this time.
6. The piece of fabric 100 may be folded a second time along fold 101b. The fold may be ironed to make it crisp. The fold may be stitched, e.g., along fold 101a, to keep it from unfolding and to add additional strength to the construction of the bandana. Alternatively or additionally, fold 101b may be stitched. Alternative constructions materials and/or techniques, such as, e.g., seam tape, sewing, glue, epoxy, and the like, may be used without departing from the scope and spirit of the present disclosure, including the claims.
7. Additional surface features may be added to the garment, depending on a particular application, as shown in FIG. 3. For example, a logo, a graphic, a symbol, or the like may be added. The logo may be located along the top edge of the garment, as indicated, e.g., by graphic 102a. A logo may alternatively or additionally be located along a lower edge, as indicated, e.g., by graphic 102b. The garment may also include a closure device 104a, 104b for securing the garment around the wearer's head. Examples of suitable closures include, e.g., Velcro®, snaps, buttons, buckles, straps, clamps, and the like. On the garment 100 shown in FIG. 3, closure 104a is on the upper or visible surface of garment 100 while closure 104b is on the underside. Additionally, the fabric 100 may include additional lines of stitching 130, 132 to increase strength, maintain a finished look and the like. When a wearer places the garment around his head, closure 104a and closure 104b will face each other, enabling the closures 104a, 104b to secure the garment around the wearer's head. Garments lacking closure 104a, 104b may be secured by simply tying the ends together.

As can be seen from FIGS. 1-3, the filter material may extend from the wearer's ears across the entire face and down to the tip of the garment which comes to rest on the wearer's chest. This may significantly increase the filter capacity and/or air flow as compared to traditional store-bought dust masks. Moreover, the filter provides an increased level of respiratory protection from dirt, dust, allergens, and the like.

While the present disclosure has been described in terms of exemplary embodiments, those skilled in the art will recognize that the present disclosure can be practiced with modifications in the spirit and scope of the appended claims. These examples given above are merely illustrative and are not meant to be an exhaustive list of all possible designs, embodiments, applications or modifications of the present disclosure.

What is claimed is:

1. A breathing mask comprising:
a sheet of flexible material folded on itself, resulting in a first layer and a second layer;
a filter located between the first layer and the second layer; and
a nose bridge located along an edge of the folded sheet, the nose bridge configured to form a seal between the folded sheet and a user's nose when the mask is placed on a user's face.

2. The breathing mask of claim 1, wherein the flexible material is fabric.

3. The breathing mask of claim 1, wherein the flexible material is cotton.

4. The breathing mask of claim 1, further comprising an opening that is configured to receive an earplug.

5. The breathing mask of claim 1, wherein the filter comprises cotton, bamboo, or a blend of cotton and bamboo.

6. The breathing mask of claim 1, wherein the nose bridge comprises a strip of metal.

7. The breathing mask of claim 1, wherein the breathing mask is assembled with stitching.

8. The breathing mask of claim 1, further comprising a closure device.

9. The breathing mask of claim 8, wherein the closure device is selected from the group consisting of a strip of Velcro, a button, a snap, a buckle, and an elastic band.

10. A breathing mask comprising:
a sheet of fabric folded on itself, resulting in a first layer and a second layer;
a filter located between the first layer and the second layer; and
a nose bridge located along an edge of the folded sheet, the nose bridge configured to form a seal between the folded sheet and a user's nose when the mask is placed on a user's face.

11. The breathing mask of claim 10, wherein the fabric comprises cotton.

12. The breathing mask of claim 10, further comprising an opening that is configured to receive an earplug.

13. The breathing mask of claim 10, wherein the filter comprises a blend of cotton and bamboo.

14. The breathing mask of claim 10, wherein the nose bridge comprises a strip of metal.

15. The breathing mask of claim 10, wherein the breathing mask is assembled with stitching.

16. The breathing mask of claim 10, further comprising a closure device.

17. The breathing mask of claim 16, wherein the closure device is selected from the group consisting of a strip of Velcro, a button, a snap, a buckle, and an elastic band.

18. A breathing mask comprising:
a sheet of fabric folded on itself, resulting in a first layer and a second layer;
a filter sandwiched between the first layer and the second layer; and
a nose bridge located along an edge of the folded sheet, the nose bridge configured to form a seal between the folded sheet and a user's nose when the breathing mask is placed on a user's face.

19. The breathing mask of claim 18, further comprising an opening that is configured to receive an earplug.

20. The breathing mask of claim 18, further comprising a closure device selected from the group consisting of a strip of Velcro, a button, a snap, a buckle, and an elastic band.
